(19) United States
(12) Patent Application Publication
(10) Pub. No.: US 2004/0122583 A1
(43) Pub. Date: Jun. 24, 2004

(54) Method and device for controlling an internal combustion engine

(76) Inventors: Holger Plote, Ennsdorf (AT); Andreas Krautter, Steinheim (DE); Michael Walter, Kornwestheim (DE); Juergen Sojka, Gerlingen (DE)

Correspondence Address: KENYON & KENYON, ONE BROADWAY, NEW YORK, NY, 10004, US

(21) Appl. No.: 10/469,934

(22) PCT Filed: Feb. 26, 2002
(86) PCT No.: PCT/DE02/00701

(30) Foreign Application Priority Data
Mar. 3, 2001 (DE) 101 10 340.9

(51) Int. Cl. F02D 41/00

(52) U.S. Cl. 701/108; 60/611; 60/278

(57) ABSTRACT

A method and a device for controlling an internal combustion engine are described. The internal combustion engine includes an exhaust-gas aftertreatment system. The control and/or regulation of the air quantity supplied to the internal combustion engine are/is implemented as a function of a variable characterizing the exhaust-gas aftertreatment system.

### BACKGROUND INFORMATION

The present invention is directed to a method and a device for controlling an internal combustion engine.

Methods and devices for controlling an internal combustion engine are known. Internal combustion engines, especially diesel gasoline engines, are frequently equipped with exhaust-gas aftertreatment systems, which include a particulate filter, in particular. These exhaust-gas aftertreatment systems influence the flow of the exhaust gas, in particular the resistance to flow in the exhaust-gas line. This is problematic especially in systems in which the exhaust gases are returned into the intake line, or in which the exhaust gases drive a turbine, as is the case in an exhaust-gas turbocharger, for example.

Such systems with exhaust-gas recirculation and/or exhaust-gas turbochargers are usually controlled and/or regulated as a function of the operating state of the internal combustion engine. If the resistance to flow of the exhaust-gas aftertreatment system changes during the same operating state, different exhaust-gas recirculation rates, or different charge-air quantities, are realized in response to the same control signal. This results in an imprecise control of the exhaust-gas recirculation or of the air quantity supplied to the internal combustion engine.

### SUMMARY OF THE INVENTION

Since the control and/or the regulation of the air quantity supplied to the internal combustion engine are/is implemented as a function of a variable characterizing the exhaust-gas aftertreatment system, these effects of the exhaust-gas aftertreatment system on the control of the air quantity may be minimized.

It is particularly advantageous that the control and/or regulation of the air quantity are/is implemented as a function of a variable characterizing the resistance to flow of the exhaust-gas aftertreatment system. As a variable that is particularly easy to measure, the differential pressure across the exhaust-gas aftertreatment system and/or the pressure upstream of the exhaust-gas aftertreatment are/is used. In a particulate filter, it is especially advantageous if a variable is used that characterizes the loading state of the particulate filter.

To control the air quantity, an actuator for influencing the exhaust-gas recirculation rate and/or a controllable exhaust-gas turbocharger are/is preferably used.

A limiting value for the control signal, a precontrol value and/or a control value of an actuator is preferably corrected as a function of the variable. Furthermore, it may also be provided that a signal is corrected that is used to generate a control signal, the limiting value and/or the precontrol value.

Of particular importance are furthermore the realizations in the form of a computer program having program-code means, and in the form of a computer program product having program-code means. The computer program of the present invention has program-code means for carrying out all the steps of the method according to the present invention when the program is executed on a computer, particularly a control unit for an internal combustion engine of a motor vehicle. In this case, the present invention is therefore realized by a program stored in the control unit, so that this control unit, which is provided with the program, constitutes the present invention in the same way as the method for whose execution the program is suitable. The computer program product of the present invention has program-code means, which are stored on a computer-readable data carrier in order to carry out the method of the present invention when the program product is executed on a computer, particularly a control unit for an internal combustion engine of a motor vehicle. Thus, in this case the present invention is realized by a data carrier, so that the method of the present invention may be executed when the program product, i.e. the data carrier, is integrated into a control unit for an internal combustion engine, particularly of a motor vehicle. In particular, an electrical storage medium, e.g. a read-only-memory (ROM), an EPROM or even an electrical permanent storage such as a CD-ROM or DVD may be used as data carrier, i.e. as computer program product.

Advantageous and expedient embodiments and further refinements of the present invention are characterized in the subclaims.

### BRIEF DESCRIPTION OF THE DRAWING

In the following, the present invention is explained with reference to the specific embodiments shown in the drawing.

The figures show:

FIG. 1 a block diagram of a system for controlling an internal combustion engine;

FIG. 2 a block diagram of an exhaust-gas recirculation regulation; and

FIG. 3 a block diagram of a charging-pressure control.

### DESCRIPTION OF THE EXEMPLARY EMBODIMENTS

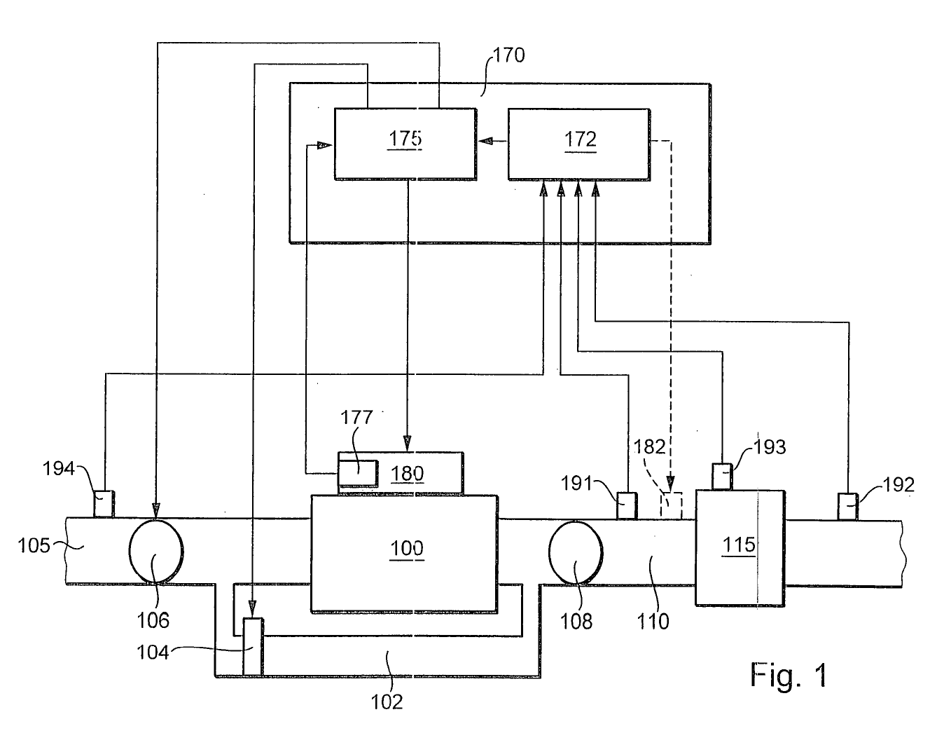

FIG. 1 shows the essential elements of an exhaust gas aftertreatment system of an internal combustion engine. The internal combustion engine is denoted by 100. It is supplied with fresh air through a fresh-air pipe 105. The exhaust gases of internal combustion engine 100 get into the environment through an exhaust pipe 110. An exhaust gas aftertreatment system 115 is arranged in the exhaust pipe. This may be a catalytic converter and/or a particulate filter. Moreover, it is possible to provide several catalytic converters for different pollutants, or combinations of at least one catalytic converter and one particulate filter.

Also provided is a control unit 170, which includes at least one engine control unit 175 and an exhaust gas aftertreatment control unit 172. Engine control unit 175 applies control signals to a fuel metering system 180. Exhaust gas aftertreatment control unit 172 applies control signals to engine control unit 175 and, in one embodiment, to a control element 182, which is arranged in the exhaust pipe upstream of the exhaust-gas aftertreatment system or in the exhaust-gas aftertreatment system.

Moreover, it is possible to provide various sensors, which feed signals to the exhaust-gas aftertreatment control unit and to the engine control unit. Thus, provision is made for at least one first sensor 194, which delivers signals characterizing the state of the air, which are fed to the internal combustion engine. A second sensor 177 delivers signals characterizing the state of fuel metering system 180. At least one third sensor 191 delivers signals characterizing the state of the exhaust gas upstream of the exhaust gas aftertreatment system. At least one fourth sensor 193 delivers signals characterizing the state of exhaust gas aftertreatment system 115.

Moreover, at least one sensor 192 can deliver signals characterizing the state of the exhaust gases downstream of the exhaust gas aftertreatment system. Preferably used are sensors that measure temperature values and/or pressure values. Moreover, sensors may also be used that characterize the chemical composition of the exhaust gas and/or of the fresh air. They are, for example, lambda sensors, NOX sensors or HC sensors.

The output signals of first sensor 194, of third sensor 191, of fourth sensor 193 and of fifth sensor 192 are preferably applied to exhaust gas aftertreatment control unit 172. The output signals of second sensor 177 are preferably applied to engine control unit 175. It is also possible to provide further sensors (not shown), which characterize a signal with respect to the driver's input or further ambient conditions or engine operating states.

In the specific embodiment shown, a compressor 106 is disposed in induction pipe 105, and a turbine 108 is arranged in exhaust pipe 110. The turbine is driven by the exhaust gas flowing through and drives compressor 106 in a manner not shown. The air quantity the compressor compresses may be controlled by suitable triggering.

Furthermore, pipe 110 is connected for an exhaust-gas recirculation pipe 102 to induction pipe 105. Disposed in exhaust-gas recirculation pipe 102 is an exhaust-gas recirculation valve 104, which is likewise controllable by control unit 175.

In the specific embodiment shown, both an exhaust-gas recirculation and a controllable exhaust-gas turbocharger are provided. According to the present invention, it is also possible to provide only an exhaust-gas recirculation, and only a controlled exhaust-gas turbocharger.

It is particularly advantageous if the engine control unit and the exhaust gas aftertreatment control unit form one structural unit. However, provision may also be made for them to be designed as two spatially separated control units.

In the following, the procedure of the present invention is described using as an example a particulate filter, which is used particularly for direct-injection internal combustion engines. However, the procedure according to the invention is not limited to this use; it may also be used for other internal combustion engines having an exhaust gas aftertreatment system. It can be used, in particular, in the case of exhaust gas aftertreatment systems featuring a combination of a catalytic converter and a particulate filter. Moreover, it is usable in systems which are equipped only with a catalytic converter.

Based on the existing sensor signals, engine control 175 calculates control signals for sending to fuel metering system 180. This then meters in the appropriate fuel quantity to internal combustion engine 100. During combustion, particulates can develop in the exhaust gas. They are trapped by the particulate filter in exhaust gas aftertreatment system 115. In the course of operation, corresponding amounts of particulates accumulate in particulate filter 115. This impairs the functioning of the particulate filter and/or of the internal combustion engine. Therefore, provision is made for a regeneration process to be initiated at certain intervals or when the particulate filter has reached a certain loading condition. This regeneration may also be referred to as a special operation.

The loading condition is detected, for example, on the basis of various sensor signals. Thus, first of all, it is possible to evaluate the differential pressure between the input and the output of particulate filter 115. Secondly, it is possible to ascertain the loading condition on the basis of different temperature and/or different pressure values. In addition, it is possible to utilize further variables to calculate or simulate the loading condition. A suitable procedure is known, for example, from German Patent DE 199 06 287.

When the exhaust gas aftertreatment control unit detects the particulate filter to have reached a certain loading condition, the regeneration is initialized. Various possibilities are available for regenerating the particulate filter. Thus, first of all, provision may be made for certain substances to be fed to the exhaust gas via control element 182, which then cause a corresponding reaction in exhaust gas aftertreatment system 15. These additionally metered substances cause, inter alia, an increase in temperature and/or an oxidation of the particulates in the particulate filter. Thus, for example, provision can be made for fuel and/or an oxidizing agent to be supplied via control element 182.

In one embodiment, provision can be made that a corresponding signal is transmitted to engine control unit 175 and that the engine control unit carries out a so-called post-injection.

The post-injection makes it is possible to selectively introduce hydrocarbons into the exhaust gas, which contribute to the regeneration of the exhaust gas aftertreatment system 115 via an increase in temperature.

Usually, provision is made to determine the loading condition on the basis of a variety of variables. By comparison to a threshold value, the different conditions are detected and the regeneration is initiated as a function of the detected loading condition.

Exhaust-gas recirculation is provided in order to reduce the nitrogen oxide in internal combustion engines. The portion of recirculated exhaust gases or the portion of the air quantity supplied to the internal combustion engine must be precisely adjusted, since the particulate emission rises if the exhaust-gas recirculation rate is too high, and the NOx emission increases if the exhaust-gas recirculation rate is too low. To this end, a control and/or regulation of the exhaust-gas recirculation rate as a function of the operating point are/is usually provided.

This is preferably implemented as a function of the engine speed and the injected fuel quantity. The setpoint values for the regulation, which were ascertained on the basis of the above variables, or the ascertained control values for the control may additionally be corrected as a function of further operating parameters, such as the atmospheric pressure, the air temperature and/or the engine temperature.

When using an exhaust-gas aftertreatment system, especially a particulate filter, the filter loading results in a change in the exhaust-gas counterpressure and thus also in the exhaust-gas recirculation rate in the same operating point. According to the present invention, a variable characterizing this effect is determined and correspondingly corrects the exhaust-gas recirculation rate or the control signal for the control element on the basis of this variable. Preferably utilized for this purpose is a pressure signal, which characterizes the pressure upstream of exhaust-gas aftertreatment system 115.

If the internal combustion engine is equipped with a mass air-flow sensor 194, the air mass is able to be regulated. In this case, it is possible to correct deviations that originate from the exhaust-gas aftertreatment system. In controlled operation and/or in systems without open loop control, the change is not detected; in these cases the control variable must be corrected.

According to the present invention, the exhaust-gas recirculation is corrected using the pressure signal, which is usually already detected to control the exhaust-gas aftertreatment system. This procedural manner is particularly advantageous, since it requires no additional components, such as sensors. The sensors that are utilized are already present to control and/or monitor the exhaust-gas aftertreatment system.

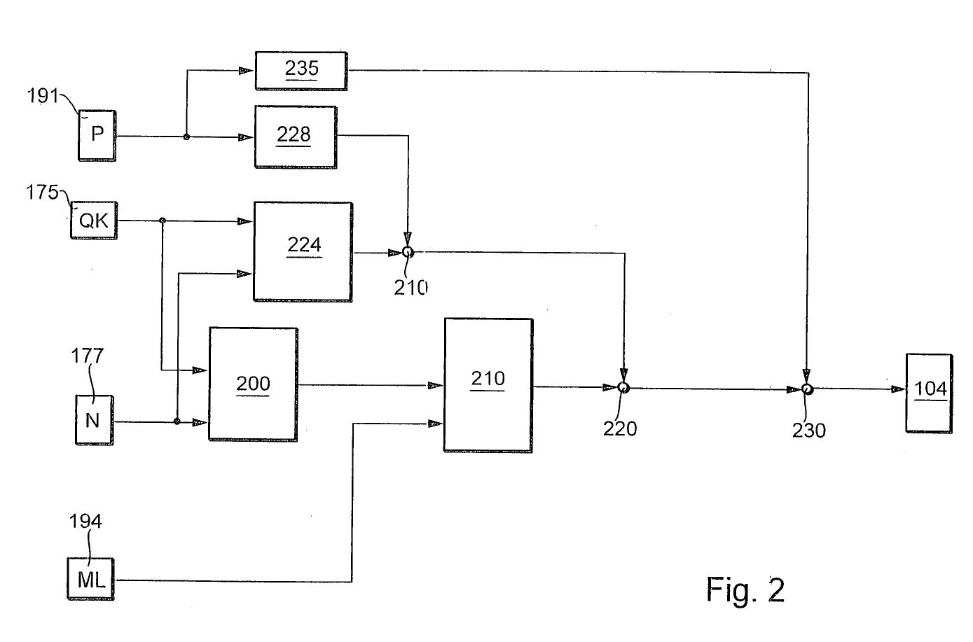

One specific embodiment of such a correction of the control signal for an actuator 104 of an exhaust-gas recirculation system is illustrated in more detail in FIG. 2. Elements which have already been described in FIG. 1 are denoted by corresponding reference symbols.

Different variables characterizing the operating state of the internal combustion engine are conveyed to a setpoint selection 200. In the specific embodiment shown, these are rotational speed N, which is detected by sensor 177, and the injected fuel quantity QK, which is provided by engine control unit 175. In addition to these variables, further variables may be taken into account as well. Substitute variables characterizing these variables may be used in place of the variables mentioned. For example, the triggering duration of a solenoid valve, which determines the fuel metering, may be used instead of the fuel quantity.

The output signal of the setpoint selection reaches a regulator 210 to which the output signal of sensor 194 is supplied as well. Output signal ML of sensor 194 characterizes the fresh-air quantity supplied to the internal combustion engine. The output signal of controller 210 reaches an actuator 104 via a first node 220 and a second node 230. Furthermore, the output signal of a third node 226 is present at the first node. The output signal of a precontrol 224 is supplied to third node 226, to which various signals regarding the operating state of the internal combustion engine are transmitted as well. Present at the second input of node 226 is the output signal of a first pressure adjustment 228. Present at the second input of node 230 is the output signal of a second pressure adjustment 235. Transmitted to pressure adjustment 228 and pressure adjustment 235 is output signal P of pressure sensor 191, which provides a signal that characterizes the pressure in the exhaust-gas line between the internal combustion and the exhaust-gas aftertreatment system.

This system works as follows: On the basis of the operating state of the internal combustion engine, setpoint selection 200 specifies a setpoint value for the air quantity to be supplied to the internal combustion engine. Controller 210 compares this value to the measured air quantity ML and, on the basis of the deviation of the two values, determines a control signal for activating actuator 104. A precontrol is normally provided, which, on the basis of the operating state of the internal combustion engine, specifies a precontrol value, which is added to the control signal in node 220.

The detection of the air quantity is relatively sluggish and reacts slowly to changes in the control variable and/or the operating states. For this reason, a precontrol is provided, which supplies a corresponding dynamically rapid signal that reacts quickly to changes in the operating states and effects an appropriate adjustment of the control element.

In a simplified specific embodiment, precontrol 224 may be omitted or, in an even simpler specific embodiment, provision may be made for only a control of the exhaust-gas recirculation. This means that setpoint selection 200 specifies the control signal for actuator 104 directly.

Apart from actuator 104, additional control elements that influence the exhaust-gas recirculation rate may be provided.

On the basis of the exhaust-gas pressure downstream from the internal combustion engine and/or upstream from the exhaust-gas aftertreatment system, pressure adjustment 228 and/or pressure adjustment 235 determine(s) correction values for compensating the pressure dependency of the exhaust-gas recirculation rate. This means that the correction values are set such that the same exhaust-gas recirculation rate comes about even if different pressures exist downstream of the internal combustion engine during the same operating states.

For example, this means that, in the case of a loaded particulate filter, exhaust-gas recirculation valve 104 is opened less than in the case of an unloaded particulate filter.

Internal combustion engines are normally equipped with so-called exhaust-gas turbochargers, which allow an increased air quantity to be supplied to the internal combustion engine. To control the turbocharger, a so-called waste-gate loader is usually provided, which has a bypass valve by way of which a portion of the exhaust gas may be guided past turbine 108. Furthermore, so-called VTG-loaders with a variably adjustable geometry are known in which the efficiency factor of the turbine can be changed. These adjustment options are utilized to adapt the charging pressure, i.e., the supplied air quantity, to the operating state of the internal combustion engine. Furthermore, the supercharger performance may be optimally adjusted to the internal combustion engine.

Normally, the desired charging pressure PL or the control signal for the actuator is specified as a function of the operating state of the internal combustion engine, such as rotational speed and injected fuel quantity, as well as other variables, such as the engine temperature, cooling water temperature, atmospheric pressure and/or air temperature. Both in an open loop control of the supercharger, in which the pulse duty factor is specifiable on the basis of the operating state, and also in a closed loop control of the supercharger, in which a setpoint value for the charging pressure may be predefined on the basis of the operating parameters and in which the pulse duty factor is specified in such a way that the setpoint and the instantaneous value of the charging pressure match, the control signal is limited as a function of the operating state of the internal combustion engine, especially the rotational speed and the injection quantity being taken into account. These variables are specified such that the supercharger does not exceed a maximally possible maximum speed.

In this context, the present invention provides that the loading of the particulate filter, and thus the reduction of the available pressure drop upstream of the turbine, is taken into account. As the exhaust-gas counterpressure rises with a filter loaded with particulate, the exhaust-gas energy available to the turbocharger drops. In the case of a charging-pressure controller, this leads to a correction of the pulse duty factor, since it is adjusted until the desired charging pressure setpoint value is attained. The usual limiting of the permissible pulse duty factor, which may normally only be specified as a function of the operating point or as a function of the fuel consumption, causes an unnecessarily early limiting of the pulse duty factor. The reason for this is that in an empty filter the high pressure differential would result in excessive speed, but this problem does not occur because the pressure differential is negligible. To ensure the desired pressure generation on the compressor side even if the pressure differential on the turbine side is slight, the present invention additionally corrects the limitation as a function of the exhaust-gas counterpressure, so that the entire available exhaust-gas energy may be utilized. A similar approach is taken in a charging-pressure control, when the pulse duty factor is specified directly, on the basis of the operating parameters.

According to the present invention, the exhaust-gas counterpressure is used to correct the pulse duty factor and/or to correct the limiting of the pulse duty factor. This approach has the advantage that a larger adjustment range is utilized and the adaptation range is adapted to the actually occurring pressure ratios.

If a high exhaust-gas pressure occurs because of a corresponding loading of the particulate filter, the limiting pulse duty factor may be corrected by taking the pressure into account as an additional input variable, in such a way that the desired charging pressure is able to be generated. The supercharger speed does not reach critical values here because the broadening of the setting range compensates only for the drop in the usable exhaust-gas energy due to the reduced pressure ratio via the supercharger.

Using the exhaust-gas counterpressure as additional input variable, a better adjustment of the desired charging pressure in also attained in the charging-pressure control, since here, too, the available exhaust-gas energy may be taken into account.

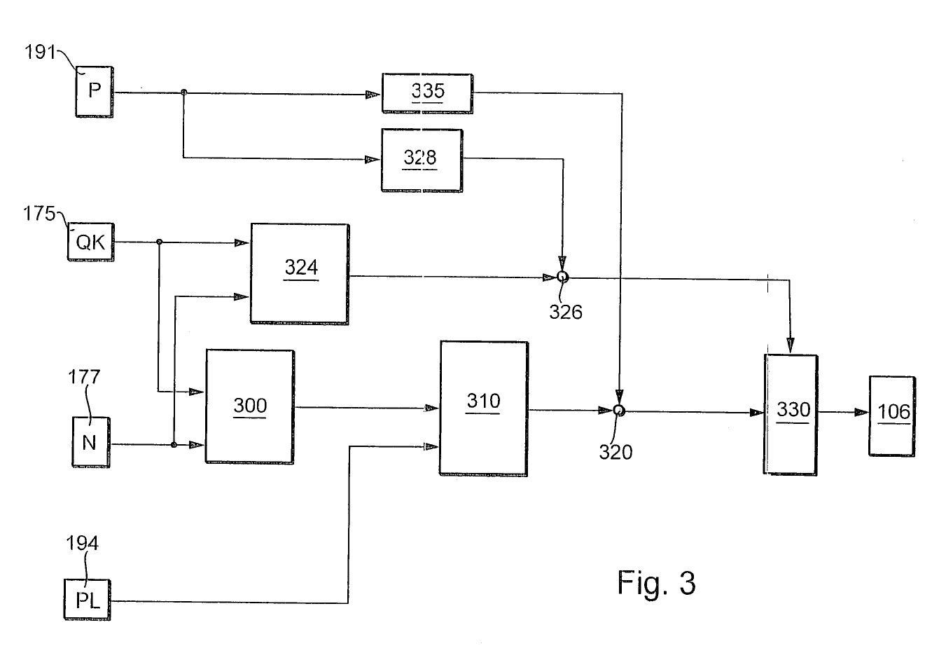

A corresponding procedure is illustrated in FIG. 3. Elements which have already been described in FIG. 1 are denoted by corresponding reference symbols.

Various variables that characterize the operating state of the internal combustion engine are fed to a setpoint selection 300. In the specific embodiment shown, these are rotational speed N, which is detected by sensor 177, and the injected fuel quantity QK, which is provided by engine control unit 175. Apart from these variables, additional variables may be taken into account as well. It is also possible to use substitute variables characterizing these variables in place of the values mentioned. For example, instead of the fuel quantity, the control duration of a solenoid valve that determines the fuel metering, may be used.

The output signal of the setpoint selection reaches a regulator 310 to which the output signal of sensor 194 is supplied as well. Output signal PL of sensor 194 characterizes the pressure of the air supplied to the internal combustion engine. The output signal of regulator 310 reaches a maximum selection 330 via a first node 220.

The variables QK and N regarding the operating state of the internal combustion engine are also supplied to a limiter 324. The output signal of the limiter reaches maximum selection 330 via a node 326. Present at the second input of the maximum selection is the output signal of node 320 at which the output signal of regulator 310, on the one hand, and the output signal of pressure correction 335, on the other hand, are present. Present at the second input of node 326 is the output signal of pressure adjustment 328. The output signal of maximum selection 330 is applied to actuator 106.

This system works as follows: On the basis of the operating state of the internal combustion engines, which is characterized, in particular, by speed N and injected fuel quantity QK, setpoint selection 300 determines a setpoint value for the charging pressure. Regulator 310 compares it to actual value PL. On the basis of this comparison, the regulator computes a control signal for actuator 106.

Maximum selection 330 limits this control signal to the output signal of limiter 324. The limiter specifies the maximum value of the control signal on the basis of the operating state of the internal combustion engine. Used for this purpose are the fuel quantity to be injected and/or the speed, in particular. According to the present invention, both the output signal of limiter 324 and the output signal of regulator 310 are corrected as a function of the pressure.

Pressure adjustment 328 and pressure adjustment 335 determine appropriate values in this context.

In a simplified specific embodiment, provision may also be made for only a control in which the control signal that is transmitted to maximum selection 330 is directly specified by setpoint selection 300.

In another specific embodiment, it may be provided that limiter 324 specifies both a maximally possible value and also a minimally possible value for the control signal and maximum selection 330 is configured as maximum selection and minimum selection. Furthermore, it may be provided that the limiting value is specifiable as a function of the fuel consumption.

What is claimed is:

1. A method for controlling an internal combustion engine, the internal combustion engine including an exhaust-gas aftertreatment system,
wherein the control and/or regulation of the air quantity supplied to the internal combustion engine are/is implemented as a function of a variable characterizing the exhaust-gas aftertreatment system.

2. The method as recited in claim 1,
wherein the control of the air quantity is implemented as a function of a variable characterizing the resistance to flow of the exhaust-gas aftertreatment system.

3. The method as recited in one of the preceding claims,
wherein the control of the air quantity is implemented by means of an actuator for influencing the exhaust-gas recirculation rate and/or with the aid of a controllable exhaust-gas turbocharger.

4. The method as recited in one of the preceding claims,
wherein, as a function of the variable, a signal is corrected that is used to generate a control signal of an actuator for controlling the air quantity.

5. The method as recited in one of the preceding claims,
wherein a limiting value for the control signal is corrected as a function of the variable.

6. The method as recited in one of the preceding claims,
wherein a precontrol value is corrected as a function of the variable.

7. A device for controlling an internal combustion engine
the internal combustion engine including an exhaust-gas aftertreatment system,
wherein means are provided, which control and/or regulate the air quantity supplied to the internal combustion engine as a function of a variable characterizing the exhaust-gas aftertreatment system.

8. A computer program having program-code means for carrying out all steps of any of claims 1 through 11 when the program is executed on a computer, particularly a control unit for an internal combustion engine.

9. A computer program product having program-code means which are stored on a computer-readable data carrier in order to carry out the method according to any of claims 1 through 11 as desired when the program product is executed on a computer, particularly a control unit for an internal combustion engine.
